(19) United States
(12) Patent Application Publication
(10) Pub. No.: US 2006/0132931 A1
(43) Pub. Date: Jun. 22, 2006

(54) Catadioptric projection objective

(75) Inventors: Alexander Epple, Aalen (DE); Aurelian Dodoc, Oberkochen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 11/237,749

(22) Filed: Sep. 29, 2005

Related U.S. Application Data
(63) Continuation of application No. PCT/EP04/03708, filed on Apr. 7, 2004.

(30) Foreign Application Priority Data
Apr. 8, 2003 (DE) 103 16 428.6

(51) Int. Cl. G02B 17/00

(52) U.S. Cl. 359/726

(57) ABSTRACT

A catadioptric projection objective for imaging a pattern arranged in the object plane (102) of the projection objective into the image plane (104) of the projection objective has a catadioptric first objective part (105) having at least one concave mirror (106), and a dioptric second objective part (108) in which there is situated a pupil surface (111) near the image. At least one concave lens (140, 145) with a concave surface (140′, 145′) directed towards the pupil surface (111) is arranged in a near zone (160) of the pupil surface. There are no lenses with a strongly curved concave surface directed towards the image plane between the pupil surface and the image plane. Such projection objectives can be produced in a way which saves material in conjunction with good optical correction, and are relatively insensitive to production-induced deviations from the ideal design.

This application is a Continuation of International Patent Application PCT/EP2004/003708 filed on Apr. 7, 2004 and claiming priority from German Patent Application DE 103 16 428.6 filed on Apr. 8, 2003. Priority is claimed from German Patent Application DE 103 16 428.6 filed on Apr. 8, 2003. The disclosure of these applications is incorporated herein entirely by reference.

### BACKGROUND OF THE INVENTION

1. Field of the Invention

The invention relates to a catadioptric projection objective for imaging a pattern arranged in an object surface of the projection objective into an image surface of the projection objective.

2. Description of the Related Art

Such projection objectives are used in projection exposure machines for fabricating semiconductor components and other finely structured devices, in particular in wafer scanners and wafer steppers. They serve for projecting patterns of photomasks or lined plates, generally referred to below as masks or reticles, onto an article coated with a light-sensitive layer with very high resolution on a de-magnifying scale.

The aim in this case is to produce ever finer structures, on the one hand to enlarge the image-side numerical aperture (NA) of the projection objective, and on the other hand to use ever shorter wavelengths, preferably ultraviolet light having wavelengths of less than approximately 260 nm.

Only a few sufficiently transparent materials are still available in this wavelength range for producing the optical components, in particular synthetic silica glass and fluoride crystals, such as calcium fluoride. The Abbé constants of these materials are relatively close together, and so it is difficult to provide purely refractive systems with adequate correction of chromatic aberrations. Such systems also require a great deal of lens material which is available in suitable quality only to a very limited extent.

In view of the difficulties with colour correction and the limited availability of suitable lens materials, increasing use is being made of catadioptric systems for very high resolution projection objectives, refractive and reflecting components, that is to say lenses and concave mirrors, in particular, being combined in such systems. Rotationally symmetrical designs are possible in this case. However, an off-axis object field and image field must be used if the aim is to achieve imaging free from obscuration and vignetting. In certain types of optical systems imaging mirror surfaces are combined with beam deflection devices (beam splitters). Both systems with geometrical beam splitting, for example with one or more fully reflecting deflecting mirrors, and systems with physical beam splitters, for example polarization beam splitters, are known. Systems without planar folding mirrors are also possible.

Catadioptric projection objectives of the applicant are to be gathered, for example, from EP 1 260 845 (corresponding to US 2003/0021040 A1) or the U.S. patent application bearing Ser. No. 10/166,332. The systems are outstandingly corrected but require a relatively large amount of lens material for producing the lenses in the region near the image field. An as yet unpublished catadioptric projection objective with a beam splitter cube (BSC) of the applicant is shown in the U.S. Patent Application bearing Ser. No. 60/396,552. One feature of this design is three large, meniscus-shaped lenses in the region near the image field, which in each case have concave surfaces directed towards the image field. Large angles of incidence of the light beams, which are comparable with the image-side numerical aperture of the system or even above it, occur on the concave surfaces of the meniscuses. These large angles of incidence make a substantial contribution to the correction of monochromatic aberrations of the projection objective. A practical disadvantage of the system is that a relatively large amount of lens material is required for producing the necessary lenses.

Examples of other catadioptric projection objectives with a physical beam splitter are shown in U.S. Pat. No. 5,808,805 or U.S. Pat. No. 5,694,241. A feature of these designs is strongly curved concave surfaces, directed towards the image surface, on lenses in the region between a pupil surface near the image and the image surface.

Catadioptric projection objectives having one common straight optical axis and at least one pair of concave mirrors facing each other are also known. A system having a centered object field and a central obscuration is disclosed in U.S. Pat. No. 6,600,608. Systems with off-axis object field and free of obscuration are known, for example, from EP 1 069 448 B1, EP 1 336 887 A1, or US 2002/0024741 A1. The systems create at least one intermediate image that is reimaged by a refractive objective part into the image plane.

### SUMMARY OF THE INVENTION

It is one object of the invention to provide a catadioptric projection objective which has a very good correction state and can be produced in a way which saves material. It is another object that the imaging power of the projection objective is relatively insensitive to production-induced deviations from the ideal design such that production is simplified.

To address these and other objects the invention, according to one formulation of the invention, provides a catadioptric projection objective for imaging a pattern arranged in an object surface of the projection objective into the image surface of the projection objective, comprising:

a catadioptric objective part having at least one concave mirror; and

a dioptric objective part, arranged optically downstream of the catadioptric objective part, in which there is situated a pupil surface near the image surface;

wherein situated in a near zone of the pupil surface is at least one concave lens with a concave surface directed towards the pupil surface;

wherein no lens with a strongly curved concave surface having a surface aperture k of less than 0.8 and being directed towards the image surface is situated between the pupil surface and the image surface, with k being the ratio r/D between the radius r of the concave surface and the maximum useful diameter D of the concave surface; and

wherein at least two of four lenses closest to the image surface are produced from a fluoride crystal material and a crystallographic <100> axis of the crystal material is aligned substantially parallel to an optical axis of the projection objective.

Advantageous developments are specified in the dependent claims. The wording of all the claims is incorporated in the description by reference.

A “concave lens” in the meaning of this application is a lens in which at least one lens surface is concave or hollow. This lens surface is denoted as a concave surface. Depending on the curvature of the other lens surface, this may be a biconcave negative lens, a plano-concave negative lens, a negative meniscus lens or a positive meniscus lens.

One aspect of the invention therefore envisages providing concave surfaces having a specific alignment or orientation in preferred regions of the projection objective near the pupil surface closest to the image, and avoiding a specific type of concave surface in other regions, specifically between the pupil surface and the image surface. It is thereby possible to provide the large angles of incidence advantageous for monochromatic correction in the region near the pupil, without a need to use lenses, the production of which requires the processing of a large amount of lens material (blank mass) relative to their size.

“Pupil surface” in the meaning of this application is to be understood as a surface in which a beam which is axially parallel in the system image space cuts the optical axis in the case of back calculation. A system diaphragm positioned in or near this pupil surface yields an optical system which is substantially telecentric in the image space. The “near zone” of the pupil surface in accordance with this application is a region of relatively large beam diameter near the pupil surface. The near zone in this case extends on both sides of the pupil surface in an axial direction, for example, up to 1.5 times or 2 times the maximum useful beam bundle diameter in the region of the pupil surface. This diameter is also denoted here as diaphragm diameter since a physical diaphragm for limiting the numerical aperture of the system can be provided in the region of the pupil surface. The position of the pupil surface closest to the image is therefore also denoted as “diaphragm position”. However, a physical diaphragm (aperture stop) is not mandatory at this location.

A “strongly curved” concave surface in the meaning of the application occurs in particular when it holds for a surface aperture k of the corresponding concave surface k<1. The ratio r/D between the radius r of the concave surface and the maximum useful diameter D of the concave surface (optically free diameter) is denoted here as surface aperture k. It is particularly advantageous when no concave surface whose k factor is smaller than 0.8, in particular smaller than 0.7, is situated between the pupil surface and the image plane. By contrast, weaker curvatures, for example, with k factors of more than approximately 2.3 or 4 can be advantageous for the correction.

A particularly advantageous ratio of corrective action to material use can be achieved whenever the concave surface (directed towards the pupil surface) is situated in a region with a substantially changing beam diameter between a region with a smaller beam diameter and a region with a larger beam diameter, and whenever the concave surface faces the region with a larger beam diameter, in this case. The concave surface is therefore preferably opposed to the beam path. Large angles of incidence can thereby be achieved for the correction despite a small sag and low material use.

If, for example, such a concave lens is placed in a region of convergent radiation between the pupil surface and image plane, it can be achieved that large angles of incidence occur at the front side or entrance side of the lens where the course of the beam path is already convergent. When a concave lens is placed upstream of the pupil surface, the latter should be arranged in the divergent beam path such that large angles of incidence occur at the rear side or exit side of the lens facing the pupil surface, where the beam path has a substantially divergent beam pencil.

Convergent radiation in the meaning of this application occurs whenever the paraxial back focus of the component objective upstream of the concave surface respectively considered is positive. In this case, the component objective situated upstream of the concave surface would produce a real image downstream of the position of the concave surface. The paraxial marginal ray angle u of the lens interspace upstream of the concave surface is convergent in this case and can be specified by its numerical aperture NA=n*sin(u), n>>1 being the refractive index of the lens interspaces. Accordingly, a divergent beam path is present when the paraxial back focus at the concave surface is negative. In this case, a component objective situated upstream of the position of the concave surface would produce a virtual image in the light path upstream of the concave surface.

The extent or the amount of convergence or divergence can be quantified above the value of sin(u), that is to say the numerical aperture of the paraxial marginal ray angle u, it being possible to use the paraxial back focus to measure the value of the sign which is decisive for convergence or divergence. Advantageous values for convergence or divergence, which leads to a strong corrective action, can be in the range of at least 30%, in particular at least 50%, of the image-side numerical aperture NA of the system.

It is particularly advantageous when at least one concave surface which is directed towards the pupil surface and at which large angles of incidence can occur is arranged both in the region of divergent beams and in the region of convergent beams. In advantageous embodiments, at least one concave surface directed towards the pupil surface is arranged upstream of the pupil surface in a divergent beam path, and at least one concave surface directed towards the pupil surface is arranged downstream of the pupil surface in the convergent beam path. It can be advantageous when in each case exactly one concave surface of this type is provided upstream and downstream of the pupil surface.

It has proved to be advantageous when the at least one concave surface is curved and arranged in such a way that the maximum sine, occurring on the concave surface, of the angle of incidence of the transiting radiation is greater than approximately 80%, in particularly greater than approximately 90%, of the image-side numerical aperture of the projection objective. This holds, in particular, for numerical apertures NA≧0.6 or NA≧0.7 or NA≧0.8, that is to say for high-aperture systems. These conditions should preferably hold for all concave surfaces of the concave lenses.

“Sine of the angle of incidence” of a beam at a surface is understood as the product n*sin(i) of the refractive index n of the medium situated upstream of the surface in the light direction, and the sine of the angle i of incidence. The angle of incidence is in this case the angle enclosed by the light beam and the surface normal at the point of impingement. The “maximum sine of the angle of incidence” at a surface is understood as the maximum of the sine of the angle of incidence over all light beams impinging on this surface.

On the other hand, it can be advantageous when the at least one concave surface is arranged in a region in which the maximum numerical aperture of the radiation at the concave surface is less than approximately 80% of the image-side numerical aperture of the projection objective. Consequently, a concave lens arranged between the pupil surface and image surface should have a sufficient spacing from the region of greatest beam apertures near the image-side exit, in order, on the one hand, to use the convergence of the beam path to achieve high angles of incidence for the correction without, on the other hand, producing excessively large angles of incidence for which no optimally acting antireflection coatings of the lenses are available.

Depending on the embodiment, a concave surface directed towards the pupil surface can be arranged on a positive lens or on a negative lens. A negative lens can be of biconcave configuration for this purpose. It is preferred when the concave lens is a meniscus lens, that is to say a lens in which the entrance surface and the exit surface have the same sense of curvature. Particularly advantageous are meniscus lenses which have a negative refractive power and for which the concave surface is in each case the surface of stronger curvature.

When the concave lens is designed as a meniscus lens, it is advantageous when the meniscus lens has a slight sag Q, it being possible for the sag preferably to be in the range of Q≦1.5, in particular in the range of Q≦1 or even Q≦0.8. The sag is defined here as Q=|((1/r₁+1r₂)/2×D|, 1/r₁ and 1/r₂ denoting the surface curvatures of the entrance surface and exit surface, and D denoting the diameter of the lens. Meniscus lenses with sags from this range can be produced with particularly low material consumption, since the volume of the cylinder circumscribing the finished lens (blank volume) differs only slightly from the used volume of the completely processed lens (useful volume). In particular, the ratio V between useful volume and blank volume can be greater than 0.4 or 0.5. In some embodiments, this ratio obtains for all meniscus lenses, in particular also for the meniscus lenses of greatest diameter in the region near the pupil.

The invention facilitates designs which can be effectively managed in terms of production engineering and have a low material consumption. This also becomes clear from the type and distribution of the refractive powers in the system and in the individual lenses. In some embodiments, the sum of the negative refractive powers of all the negative lenses in the second objective part is less than approximately 10 m⁻¹, in particular less than approximately 8 m⁻¹. This low negative refractive power suffices for a complete aberration correction in conjunction with the corresponding positive refractive powers. Since only low negative refractive powers are required, the necessary positive lenses can likewise be of moderate dimensions.

In some embodiments, there is no lens with a strong negative refractive power in the second objective part. This holds, in particular, for all negative lenses j in the near zone of the pupil surface. It advantageously holds for these that: 5.0<|f_{f}/L|<0.1, fⱼ being the refractive powers of the individual negative lenses in the near zone of a pupil surface, and L being the total light path along the optical axis between the object surface and image surface. This light path can be folded once or several times. Some embodiments have at most three negative lenses in the second, refractive objective part. This saves blank mass. These advantageous refractive power relationships contribute to an unstressed design in conjunction with low material consumption.

The advantages of the invention can be achieved for catadioptric projection objectives of different constructions. Although systems without intermediate image are possible, at least one, preferably exactly one, real intermediate image is produced between the object surface and image surface. If a real intermediate image is present, the system has, in addition to the pupil surface near the image, a further pupil surface which can, for example, be situated in the catadioptric part near a concave mirror. Furthermore, the invention may be used both in systems with a geometrical beam splitter and in systems with a physical beam splitter. Consequently, advantageous designs have a catadioptric objective part with a concave mirror and a beam deflecting device. This can be situated in the light path upstream of the concave mirror, and effect a deflection of the radiation coming from the object plane in the direction of the concave mirror. It is also possible for a reflective surface of the beam deflecting device to be situated downstream of the concave mirror in the light path, in which case, if appropriate, light coming from the object plane firstly strikes the concave mirror, by which it is reflected to the mirror surface of the beam deflecting device. The invention can also be used in systems having no beam splitter, such as systems having pairs of concave mirrors facing each other, as mentioned in the introduction.

Apart from proceeding from the claims, the preceding and further features also emerge from the description and the drawings. Here, the individual features can be implemented on their own or severally in the form of subcombinations in an embodiment of the invention and in other fields and can constitute advantageous designs and designs inherently capable of protection.

### BRIEF DESCRIPTION OF THE DRAWINGS

FIG. 1 is a lens section through a first embodiment of a catadioptric projection objective with a physical beam splitter;

FIG. 2 is a lens section through a second embodiment of a catadioptric projection objective with a physical beam splitter;

FIG. 3 is a lens section through a third embodiment of a catadioptric projection objective with a geometrical beam splitter in the light path upstream of the concave mirror;

FIG. 4 is a lens section through a fourth embodiment of a catadioptric projection objective with a geometrical beam splitter in the light path downstream of the concave mirror;

FIG. 5 is a lens section through a conventional, catadioptric projection objective with a physical beam splitter; and

FIG. 6 is a schematic illustration of a microlithography projection exposure machine with a catadioptric projection objective in accordance with the invention.

### DETAILED DESCRIPTION OF THE PREFERRED EMBODIMENTS

In the following description of preferred embodiments, the term “optical axis” denotes a straight line or a sequence of straight line segments through the centres of curvature of the optical components. The optical axis is folded at deflecting mirrors or other reflecting surfaces. Directions and spacings are described as “image-side” when they are directed in the direction of the image plane or the substrate to be exposed that is located there, and as “object-side” when they are directed with reference to the optical axis towards the object plane or a reticle located there. In the examples, the object is a mask (reticle) with the pattern of an integrated circuit, but there can also be another pattern, for example a grating. In the examples, the image is projected onto a wafer provided with a photoresist layer and serving as substrate. Other substrates, for example elements for liquid crystal displays or substrates for optical gratings, are also possible.

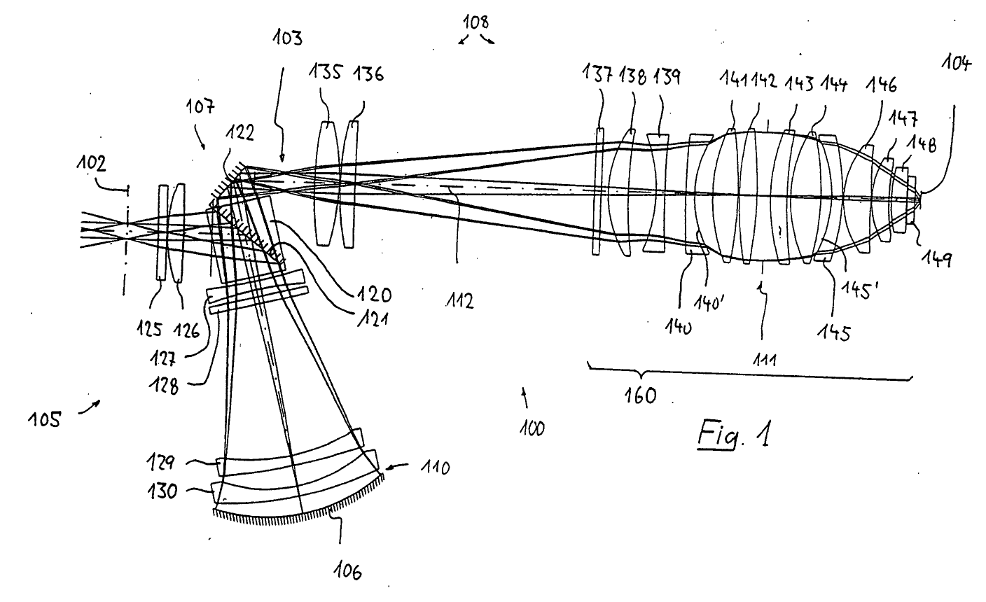

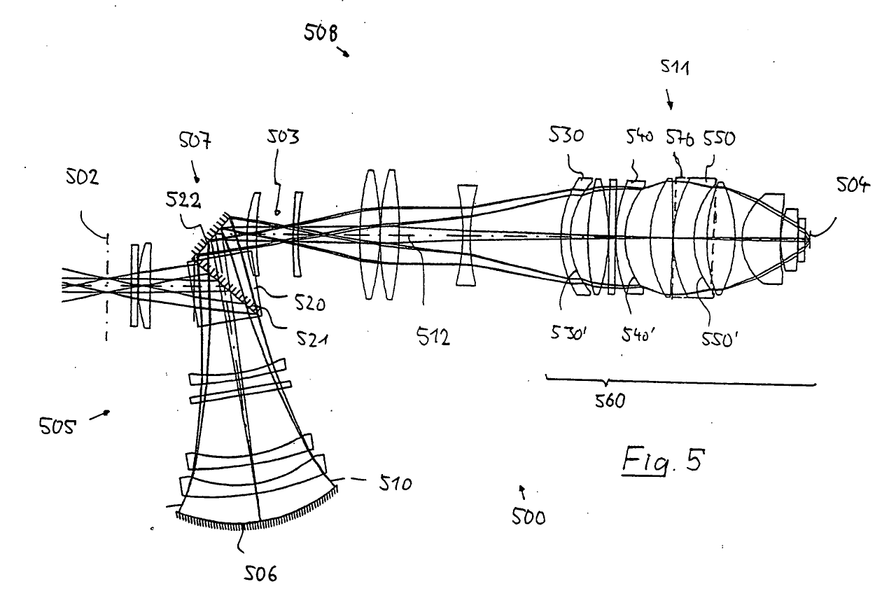

As an introduction to the problems on which the invention is based, a catadioptric projection objective with a physical beam splitter of the prior art is firstly explained with the aid of FIG. 5. The projection objective corresponds to the embodiment which is shown in FIG. 1 of the U.S. Patent Application Ser. No. 60/396,552 (publication date 18.07.2002) of the applicant. The associated description is incorporated by reference in the contents of this application.

The projection objective 500 with physical beam splitting serves the purpose of imaging a pattern, arranged in its object plane 502, of a reticle or the like into an image plane 504, situated parallel to the object plane, on a reduced scale (4:1) by producing a single, real intermediate image 503. Between the object plane 502 and the image plane 504, the objective has a catadioptric first objective part 505 with a concave mirror 506, and a beam deflecting device 507 as well as a second dioptric objective part 508, which follows the catadioptric objective part and contains exclusively refractive optical components.

Since the projection objective produces a real intermediate image 503, two real pupil planes 510, 511 are present, specifically a first pupil plane 510 in the catadioptric objective part directly upstream of the concave mirror 506, and a second pupil plane 511 in the region of greatest beam diameter in the dioptric objective part in the vicinity of the image plane 504. The main imaging beam crosses the optical axis 512 of the system in the regions of the pupil planes 510, 511. The pupil planes 510, 511 are mutually optically conjugate diaphragm sites, that is to say preferred sites in the region of which a physical diaphragm can be positioned for limiting the beam bundle cross section and for adjusting the numerical aperture used. A particular feature of this system consists in that the system diaphragm 515 is positioned with a variably adjustable diaphragm diameter directly upstream of the concave mirror 506 in the catadioptric objective part.

The beam deflecting device 507 comprises a physical beam splitter with a beam splitter cube 520 in which a polarization-selective beam splitter surface 521 is arranged diagonally. The plane beam splitter surface aligned obliquely to the optical axis serves for deflecting appropriately linearly polarized object light to the concave mirror 506, and is designed such that light coming from the concave mirror 506 is transmitted with the direction of polarization rotated by 90° to a deflecting mirror 522 whose plane mirror surface is aligned perpendicular to the beam splitter surface 521, and reflects the light to the refractive objective part in the direction of the image plane.

A particular feature of this objective is three large meniscus-shaped negative lenses 530, 540, 550 in the region of the refractive objective part 508 near the image field. These lenses are situated in a near zone 560 of the pupil surface 511 near the image field. This near zone is distinguished by relatively large beam bundle diameters and extends from a site directly upstream of the first negative meniscus lens 530 up to the image plane 504, that is to say in a range of approximately ±1.5 diaphragm diameters about the pupil surface 511. The diameter of the beam bundle at the pupil surface 511 closest to the image field is denoted here as diaphragm diameter.

The negative meniscus lenses 530, 540, 550 are respectively concave or hollow relative to the image surface 504. Maximum values of the sine of the angles of incidence of the light beams occur at the image-side concave surfaces 530′, 540′, 550′ of the meniscuses and are greater than approximately 90% of the numerical aperture of the system (NA=0.85), or are even above this value. The large angles of incidence at the concave surfaces 530, 540, 550 contribute substantially to the correction of monochromatic aberrations of the projection objective. However, producing a large angle of incidence in the region, near the image field, downstream of the pupil surface 511 on the concave surface 550′ of a meniscus which is hollowed towards the wafer requires the sag of the meniscus to be very large, since the beam path at the exit of the meniscus already converges substantially towards the image field 504. This large sag means, however, that the blank (lens blank) required for producing the lens needs a great deal of lens material. The shape of the lens blank 570 required for producing the lens 550 is drawn in as dashes in FIG. 5. The ratio V of the volume of the finished lens to the volume of the lens blank 570 is approximately 0.56 for this meniscus lens 550, and approximately 0.37 and 0.48, respectively, for the meniscuses 530, 540. The production of these large lenses, and thus of the objective overall, is therefore relatively expensive in material terms. It is to be borne in mind here that the ratio V becomes more advantageous as the centre thickness of a lens increases given a constant sag. The values specified here are relatively advantageous and can be acceptable.

The invention facilitates a substantial reduction in material consumption in the case of an optical correction which is comparable to the art or better, it being possible, in addition, to simplify the production further by “relaxing” specifications.

A first embodiment of an inventive catadioptric projection objective 100 with physical beam splitting is shown in FIG. 1. The said objective serves to image a pattern arranged in its object plane 102 into its image plane 104 in a de-magnifying fashion in a scale of 4:1 by producing a real intermediate image 103, and has between the object plane and image plane a catadioptric first objective part 105, with a concave mirror 106, and a beam deflecting device 107 as well as a purely refractive second objective part 108. Since a real intermediate image 103 is produced, two real pupil surfaces 110, 111 are present, the pupil surface 111 closest to the image field being positioned in the region of greatest beam diameter of the refractive part. The site of the pupil surface 111 closest to the image (diaphragm site) is free of lenses, and so a system diaphragm 115 for variably limiting the cross section of the beam passing through the objective can conveniently be provided in this region in order to adjust the aperture of the objective actually used. Alternatively, a system diaphragm can be provided at the conjugate diaphragm side 110 upstream of the concave mirror 106.

The beam deflecting device 107 comprises a physical beam splitter with a beam splitter cube 120 in which a polarization-selective beam splitter surface 121 is arranged diagonally. The plane beam splitter surface aligned obliquely to the optical axis 112 serves for deflecting appropriately linearly polarized object light to the concave mirror 106, and is designed such that light coming from the concave mirror 106 is transmitted to a deflecting mirror 122 with a direction of polarization rotated by 90°, the plane mirror surface of which deflecting mirror 122 is aligned perpendicular to the beam splitter surface 121. Whereas the beam splitter surface 121 is required for deflecting the object light in the direction of the concave mirror 106, the deflecting mirror 122 can also be eliminated. The object plane and the image plane would then be substantially perpendicular to one another without further deflecting mirrors. The parallel setting of object plane 102 and image plane 104, achieved by the deflecting mirror 122, is however advantageous for operating a scanner of the projection exposure machine comprising the projection objective.

The light of an illuminating system (not shown) enters the projection objective on the side of the object plane 102 averted from the image, and firstly penetrates the mask arranged in the object plane. The transmitted light thereafter penetrates a plane-parallel plate 125 and a positive lens 126, which focuses the radiation and thereby facilitates relatively small diameters of the beam splitter cube 120. The linear polarization of the input light is aligned such that the beam splitter surface 121 acts to reflect the light such that the input light is deflected in the direction of the concave mirror 106. In accordance with the arrangement of the concave mirror in an oblique horizontal arm of the projection objective, the deflecting angle is more than 90°, for example 103 to 105°. In the horizontal arm, the light firstly strikes a negative meniscus lens 127. Downstream of the latter can be arranged a polarization rotation device in the form of a λ/4 plate 128 which converts the entering, linearly polarized light into circularly polarized light. The latter penetrates two negative meniscus lenses 129, 130 placed directly upstream of the concave mirror 106 before it strikes the concave mirror. The light reflected by the concave mirror 106 and returned through the doubly transited lenses 127 to 130 in the direction of the beam deflecting device 107 is converted by the λ/4 plate into light with linear polarization, which is transmitted by the beam splitter surface 121 in the direction of the deflecting mirror 122. The light reflected by the deflecting mirror 122 forms the intermediate image 103 with a spacing downstream of the mirror surface 122. The said intermediate image is imaged into the image plane 104 by the subsequent lenses 135 to 149 of the refractive objective part 108, which have a de-magnifying effect overall.

The lenses serving for imaging the intermediate image 103 into the image plane 104 comprise a biconvex positive lens 135 following the intermediate image, and a positive lens 136 arranged downstream thereof, which act together as a field lens group and make a substantial contribution to the distortion correction. The lenses following with a large spacing in the near zone 160 of the pupil surface 111 near the image serve overall to correct errors dependent on aperture. They comprise, in this sequence, a virtually plane-parallel lens 137 of weak refractive power, a positive meniscus lens 138 with an image-side concave surface, a biconcave negative lens 139, a negative meniscus lens 140 with a concave surface 140′, concave towards the image surface and towards the pupil surface 111, two biconvex positive lenses 141, 142 situated upstream of the pupil surface 111 and, at a spacing downstream of the pupil surface, a positive meniscus lens 143 with an image-side concave surface, a biconvex positive lens 144, a negative meniscus lens 145 with a concave surface 145′ directed towards the object or towards the pupil surface 111, a positive lens 146 with a virtually plane exit surface, a positive meniscus lens 147 with an image-side hollow, weakly curved exit surface, a positive lens 148 with a virtually plane exit surface, and a substantially plane-parallel end plate 149.

The specification of the design is summarized in tabular form in Table 1. Here, column 1 gives the number of the refracting surface, the reflecting surface, or one distinguished in another way, column 2 gives the radius r of the surface (in mm), column 3 gives the distance d, denoted as thickness, of the surface from the following surface (in mm), column 4 gives the material of a component, and column 5 gives the refractive index of the material of the component which follows the specified entrance surface. The overall length L of the objective between the object and image plane is approximately 1126 mm.

Nine of the surfaces, specifically the surfaces 5, 11, 17, 20, 26, 33, 42, 48 and 57, are aspheric in the embodiment. Table 2 specifies the corresponding aspheric data, the sagittas of the aspheric surfaces being calculated using the following rule:
p(h)=[((1/r)h²/(1+SQRT(1−(1+K)(1/r)²h²))]+C1*h⁴+C2*h⁶+ . . .

Here, the reciprocal (1/r) of the radius specifies the surface curvature at the surface apex, and h specifies the distance of a surface point from the optical axis. Consequently, p(h) gives the sagitta, that is to say the distance of the surface point from the surface apex in the z-direction, that is to say in the direction of the optical axis. The constants K, C1, C2 . . . are reproduced in Table 2.

Table 3 specifies, for the lens surfaces of the refractive part 108, the maximum angles of incidence occurring at the respective surfaces in the form of the associated sine values max sin(i), and the k factors which describe the surface aperture k=r/D (r=radius of the surface, D=optically free diameter of the surface).

The optical system 100 which can be reproduced with the aid of these data is designed for an operating wavelength of approximately 157 nm, at which the lens material of calcium fluoride used for all the lenses has a refractive index n=1.5592846. The image-side numerical aperture NA is 0.85, and the reduction ratio is 4:1. The system is designed for an image field of size 26×5.5 mm². The system is doubly telecentric.

In the near zone 160 about the pupil surface 111 near the image field, the system has a material-saving design which simultaneously permits good correction of monochromatic aberrations. A particular contribution is made to this by the two negative meniscus lenses 140 and 145, which each have a concave surface 140′ and 145′, respectively, directed towards the pupil surface 111, and are also denoted here as “concave lenses”, because of this concave surface. It is also striking that no concave surfaces of strong curvature occur in the region between the pupil surface 111 and image plane 104 at the exit sides of the lenses there. The strongest curvature with k=2.712 is present at the exit surface of the positive lens 147.

In this embodiment, the concave surfaces 140′, 145′ with high angles of incidence, which are very effective for image correction, are opposed in each case to the beam path. Thus, a first large angle of incidence with a value (sin(i)=0.85) corresponding to the numerical aperture occurs at the exit surface 140′ of the concave lens 140, where the beam path is substantially divergent, that is to say has an expanded ray pencil with respect to the pupil surface 111. In the air space downstream of this concave surface 140, the modulus |NA| of the numerical aperture is approximately 0.36, corresponding to approximately 42% of the image-side NA. It is thereby possible to achieve a large angle of incidence, given a relatively weak surface curvature and a relatively slight lens sag. This leads at this location to a lens with a relatively small blank volume. For the lens 140, the ratio V between the volume of the cylinder circumscribing the lens (corresponding to the blank volume) to the volume of the lens is approximately 0.58.

A corresponding statement holds for the concave lens 145, which is arranged in the convergent beam path between the pupil surface 111 and image plane 104. Here, a large angle of incidence (sin(i)=0.85) occurs on the entrance side 145′. Here, a value |NA|=0.50 corresponds to approximately 58% of the image-side NA. An effective correction means is thereby also possible in conjunction with a low use of material. The volume ratio V=0.48 for this lens.

The concave lens 140 has a sag Q of approximately 0.75, and the sag on the concave lens 145 is approximately 0.68.

It may also be seen from Table 3 that in the refractive part near the image (with the exception of the lenses 148, 149 closest to the image) angles of incidence whose maximum sine is greater than 90% of the image-side numerical aperture occur only at two surfaces, specifically the concave surfaces 140′ and 145′ directed towards the pupil surface 111. This substantially relieves the design and the surface sensitivities, since it is generally difficult to provide antireflection coatings of sufficient effectiveness when high angles of incidence occur at the corresponding surface. Consequently, the tolerances of the coating of all the lens surfaces can be substantially relieved, with the exception of the concave surfaces 140′ and 145′.

The correction of the system is comparable to that of the known system shown in FIG. 5, the present embodiment even having less need for an aspheric surface in order to achieve a comparable correction. The visible relief and harmonization of the objective construction by comparison with conventional designs palpably reduce the sensitivities of the design, thereby simplifying the production.

At the same time, the blank mass, that is to say the initial mass of lens material required for producing the lenses of this design, can be substantially reduced by comparison with the prior art. Whereas, for example, a total of approximately 17.7 kg of lens raw material is required for the three meniscus lenses 530, 540, 550 of the prior art (FIG. 5) necessary for correction purposes, this mass is reduced to approximately 7.1 kg in the embodiment in accordance with FIG. 1. The material requirement can be reduced by 10% or more with reference to the entire system.

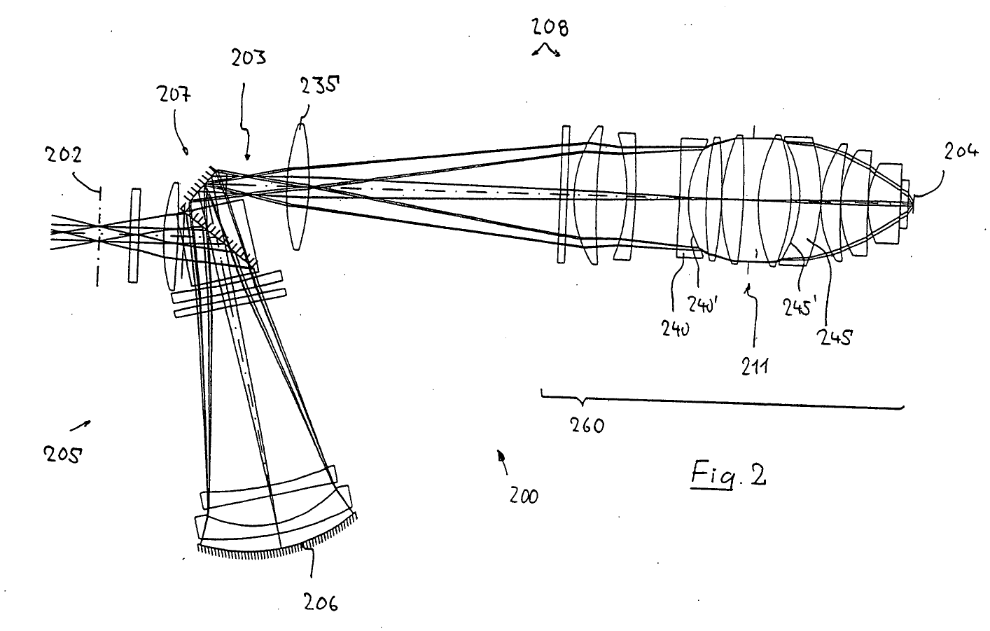

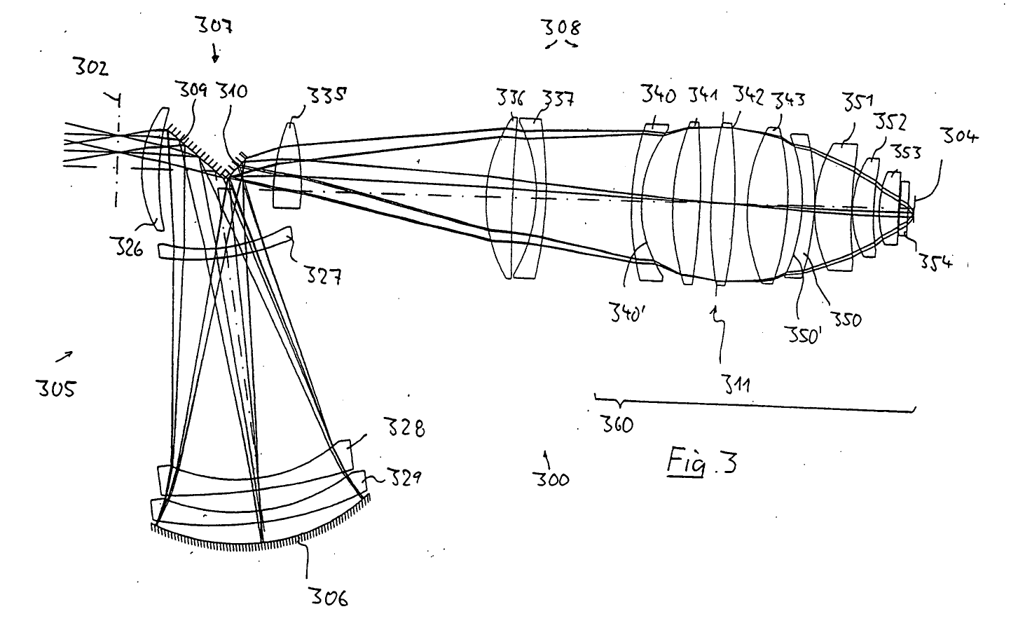

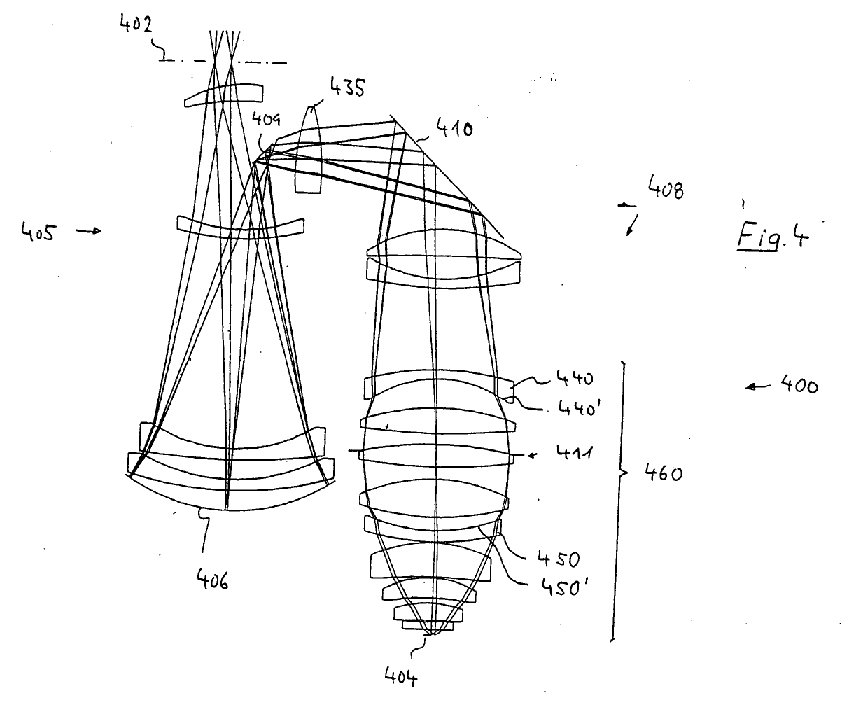

A second embodiment of a catadioptric projection objective 200 with a physical beam splitter is shown in FIG. 2, its specification being given in Tables 4 and 5. The numbering of the optical elements or subassemblies corresponds essentially to the numbering of the embodiment in accordance with FIG. 1 increased by 100. A similar statement holds for FIGS. 3 and 4 with increases by 200 and 300, respectively.

As in the case of the embodiment in accordance with FIG. 1, a concave lens 240 designed as a negative meniscus lens and having a concave surface 240′ directed towards the pupil surface 211 is arranged in the divergent beam path upstream of the pupil surface 211 near the image. A further concave lens (negative meniscus lens 245 with an entrance surface 245′ concave towards the pupil surface 211) curved relative to the beam path is arranged in the convergent beam path between the pupil surface 211 and image plane 204. The large sines, occurring at the surfaces 240′ 245′, of the angles of incidence, are 0.848 and 0.863, respectively and are therefore of the order of magnitude of the image-side NA=0.85. In the air space downstream of the surface 240′, |NA|=0.33 (approximately 39% of the image-side NA), while it holds upstream of the surface 245′ that |NA|=0.43 (corresponding to approximately 51% of the image-side NA). At Q=0.54 and Q=−0.84, respectively, the sags of the lenses 240 and 245 are very slight, and so advantageous ratios V of 0.63 (lens 240) and 0.58 (lens 245), respectively, are implemented between the lens volume and blank volume. Owing to the slightly altered curvatures and lens spaces, it is possible in this embodiment to manage with a single positive lens 244 between the pupil surface 211 and subsequent concave lens 245, and also to implement the function of the field lenses near an intermediate image by means of a single positive lens 235. By comparison with the embodiment in accordance with FIG. 1, it is thereby possible to save two lenses and thus a further fraction of lens volume.

It is shown with the aid of FIGS. 3 and 4 that the advantages of the invention are also useful for catadioptric systems with geometric beam splitting and different folding geometries. The specification for the system in accordance with FIG. 3 is given in Tables 6 and 7 and also holds, mutatis mutandis, for the embodiment in accordance with FIG. 4 in which other positions of the deflecting mirrors obtain.

The projection objective 300 (de-magnifying scale 4:1, numerical aperture NA=0.80) has a catadioptric objective part 305, with a concave mirror 306 and geometrical beam deflecting device 307, between the object plane 302 and image plane 304, and has a second objective part 308, with exclusively refracting components, downstream of the beam deflecting device. The beam deflecting device 307 is designed as reflector prism and has a first, plane reflecting surface 309 for deflecting the radiation, coming from the object plane 302, in the direction of the concave mirror, as well as a plane second reflecting surface 310, arranged at a right angle to the first reflecting surface, for deflecting the radiation, reflected by the imaging concave mirror 306 in the direction of the second objective part. Whereas the first reflecting surface 309 is required for deflecting the beam towards the concave mirror 306, the second reflecting surface 310 can also be omitted. Without further deflecting mirrors, the object plane and the image plane would then be substantially perpendicular to one another. It is also possible to provide folding inside the refractive objective part 308. The double folding permits the object plane and image plane to be positioned in parallel. The catadioptric objective part 305 produces a real intermediate image 303 which is in the vicinity of the second folding mirror 310 and is imaged into the image plane 304 with the aid of the lenses of the refractive objective part 308.

The light coming from an illuminating system and passing through the mask arranged in the object plane 302 firstly strikes a positive meniscus lens 326 before it is deflected by the first folding mirror 309 in the direction of a concave mirror 306. Transited in the light path to there are a negative meniscus lens 327 relatively near the field and two negative meniscus lenses 328, 329 arranged directly upstream of the concave mirror 306 and near the pupil, whose surfaces are convex relative to the mirror in each case. The light reflected by the concave mirror 306 and returned to the beam deflecting device 307 through the negative lenses 327, 328, 329, which are transited twice, is deflected by the second folding mirror 310 in the direction of the dioptric objective part 308, the intermediate image 303 being produced shortly before the folding. A biconvex positive lens 335 designed as a component lens serves as field lens for combining the beams of light in the direction of a lens group, following at a spacing, which is arranged between the field and pupil regions and comprises a positive meniscus lens 336 with an image-side concave surface, and a downstream negative meniscus lens 337 with an object-side concave surface. The following are situated in this sequence at a spacing downstream of this lens group in the near zone 360 of the pupil surface 311 near the image: a negative meniscus lens 340 with an image-side concave surface 340′, three consecutive biconvex positive lenses 341, 342, 343, a negative meniscus lens 350 with an object-side concave surface 350′ (directed towards the pupil surface 311), three downstream positive meniscus lenses 351, 352, 353 with in each case weakly curved, exit-side concave surfaces, as well as a plane-parallel end plate 354.

At the negative meniscus lenses 340, 350 respectively curved in relation to the beam path, large angles of incidence (maximum sin(i)=0.799 and 0.800, respectively) of the order of magnitude of the image-side numerical aperture (NA=0.85), which are very effective for monochromatic correction, occur in each case at the concave surface facing the pupil surface 311. Downstream of the surface 340′, |NA|=0.23 (approximately 27% of the image-side NA), while |NA|=0.50 (approximately 58% of the image-side NA) upstream of the surface 350′. Despite these advantageous incidence ratios, the lenses have only slight sags in each case (Q=0.86 for lens 340 and −0.65 for lens 350), and can be produced with relatively small volumes from lens blanks. The ratio V between lens volume and blank volume is approximately 0.49 for lens 340 and approximately 0.49 for lens 350.

The embodiment 400 in accordance with FIG. 4 differs in essence from objective 300 in terms of the folding geometry. Here, the light coming from the object plane 402 firstly strikes the concave mirror 400, by which it is reflected, in the direction of the deflecting mirror 409 required for functioning. After the folding there and the passage through the positive lens 435, a second folding, which permits parallel positioning of the object plane 402 and image plane 404, takes place at the plane mirror 410. Reference is made to the description relating to FIG. 3, and to the corresponding tables, for the other characteristics.

The embodiments illustrated by way of example have further advantageous special features, of which a few are mentioned below. In the systems with a physical beam splitter (FIGS. 1 and 2), the intermediate image is not situated on or in the vicinity of an optical surface but at a large spacing downstream of a folding mirror or upstream of the entrance surface of the downstream positive lens. The result is to reduce or avoid problems which could arise from imperfections, for example, contaminants, scratches, material inclusions, etc. in the region of the intermediate image. In the refractive part of all the embodiments, there are in each case no more than three negative lenses required. Since negative lenses with a negative refractive power sufficient for the correction require a relatively large amount of lens material, blank mass can thereby be saved. With the exception of the concave surfaces, facing the pupil surface near the image, of the concave lenses and a few surfaces near the image field, all the surfaces of the refractive part are loaded only with relatively small angles of incidence (compare Table 3), with the result that the design of effective optical coatings is facilitated and the production is simplified by relaxation of specifications.

In the embodiments described, all the transparent optical components consist of the same material, specifically calcium fluoride. It is also possible to use other materials which are transparent at the respective operating wavelength, in particular barium fluoride or another suitable fluoride crystal material, for example magnesium fluoride, lithium fluoride, lithium calcium aluminium fluoride, lithium strontium aluminium fluoride or the like. If appropriate, it is also possible to use at least one second material, in order, for example to support the chromatic correction. The advantages of the invention can be used for all operating wavelengths in the ultraviolet region, for example at 248 nm, 193 nm, 157 nm or 126 nm. Since only one lens material is used in the embodiments shown, it is easily possible to adapt the designs shown to other wavelengths. Particularly in the case of systems for longer wavelengths, it is also possible to use other lens materials, for example synthetic silica glass, for all or some optical components.

Some further measures can be present alone or in combination with one another in the case of one or more of the systems described, in order to improve performance further. For example, all the transparent optical components of a projection objective can be fabricated from calcium fluoride, which is favourable, in particular, for operating wavelengths of 157 nm or below. At least two of the four last lenses (for example, the lenses 146-149 in FIG. 1) situated near the image surface can consist of fluoride crystal material whose crystallographic <100> axis is aligned substantially parallel to the optical axis. Optical elements with selected crystallographic orientations can be rotated in relation to one another in order to minimize the influence of the intrinsic and/or induced birefringence of fluoride crystal materials on the image quality.

Individual optical elements, in particular lenses, can be adjustable with reference to their position and/or orientation relative to the optical axis in the case of embodiments of the inventive projection objectives. Special mounting technology with suitable manipulators can be provided for this purpose, in order to permit a displacement of the optical component perpendicular to the optical axis (x-y manipulation) and/or a displacement along the optical axis (z manipulation) and/or a tilting about a tilting axis running transverse to the optical axis. At least two optical components can preferably be manipulated in this way. In particular, it can be advantageous with catadioptric objectives of the type shown in FIGS. 1 to 3 to mount at least one of the two negative lenses (for example 129, 130 or 328, 329) arranged upstream of the concave mirror such that it can be subject to x-y manipulation. This can be advantageous, in particular, because these lenses are arranged in a side arm, projecting approximately horizontally in the installed state, of the objective and can tend to be deformed in a non-rotationally symmetrical fashion under their intrinsic weight. A remedy can be provided here by adjustment in a vertical direction, that is to say substantially perpendicular to the optical axis. Alternatively, or in addition, it can be advantageous for at least one lens arranged in the vicinity of the intermediate image to be configured to be capable of manipulation, in particular with the possibility of being displaced parallel to the optical axis (z manipulation). For example, the lenses 135, 235 or 335 can be capable of z manipulation. It is possible for z manipulation of these lenses to be advantageous since they are the only lenses near the field in this objective. Alternatively, or in addition to these possibilities, other lenses are also capable of being axially displaced, decentred and/or tilted.

Some embodiments can have a plane-parallel or virtually plane-parallel plate, that is to say an optical element exhibiting no optical effect or only a slight one, as first optical element directly downstream of the object plane and/or as last optical element directly upstream of the image plane. The objective can thereby be rendered relatively insensitive to changes in the refractive index of flushing gas as a result of pressure fluctuations and, if appropriate, insensitive to mechanical damage.

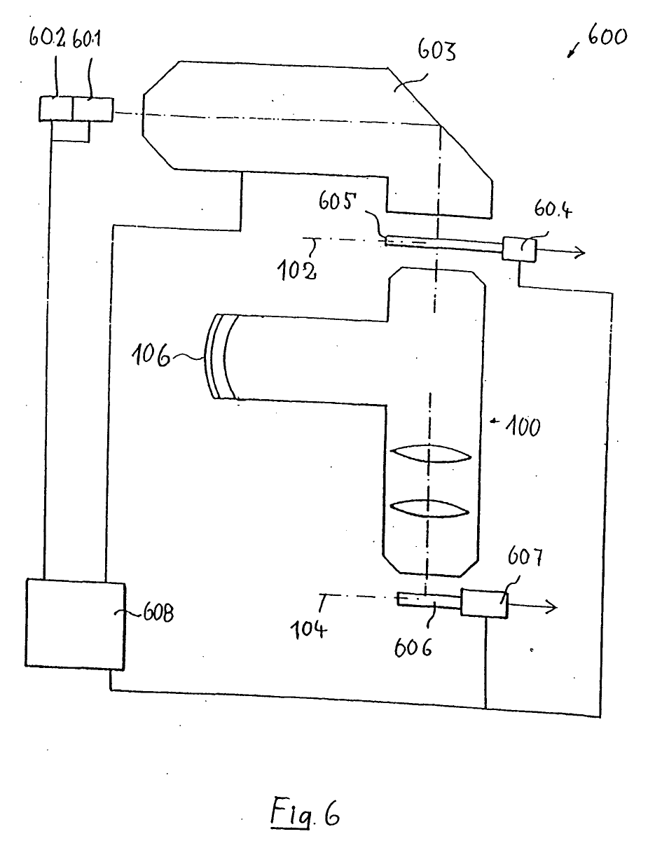

Inventive projection objectives can be used in all suitable microlithographic projection exposure machines, for example in a wafer stepper or a wafer scanner. A wafer scanner 600 is shown diagrammatically in FIG. 6. It comprises a laser light source 601 with an assigned device 602 for narrowing the bandwidth of the laser. An illuminating system 603 produces a large, sharply delimited and very homogenously illuminated image field which is adapted to the telecentricity requirements of the downstream projection objective 100. The illuminating system 603 has devices for selecting the illumination mode and can, for example, be switched over between conventional illumination with a variable degree of coherence, ring-field illumination and dipole or quadrupole illumination. Arranged downstream of the illuminating system is a device 604 for holding and manipulating a mask 605 such that the mask 605 lies in the image plane 102 of the projection objective 100 and can be moved in this plane for scanning operation. In the case of the wafer scanner shown, the device 604 correspondingly comprises the scanner drive.

Following downstream of the mask plane 102 is the projection objective 100, which images an image of the mask on a reduced scale on a wafer 606 which is coated with a photoresist layer and is arranged in the image plane 104 or the projection objective 100. The wafer 606 is held by a device 607, which comprises a scanner drive in order to move the wafer synchronously with the reticle. All the systems are controlled by a control unit 608. The design of such systems and their mode of operation are known per se and are therefore not further explained.

It is to be understood that all systems described above may be complete systems for forming a real image (e.g. on a wafer) from a real object (e.g. from a reticle). However, the systems may be used as partial systems of larger systems. For example, the “object” for a system mentioned above may be an image formed by an imaging system (relay system) upstream of the object plane. Likewise, the image formed by a system mentioned above may be used as the object for a system (relay system) downstream of the image plane.

The terms “first” and “second” objective parts are to be understood as denoting the relative position of the objective parts along the path of the radiation beam. In this sense, the second objective part picks up the radiation emerging from the first objective part. The first objective part must not be the first objective part immediately following the object plane. A relay system may be inserted between the object plane and the first objective part.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications that fall within the spirit and scope of the invention, as defined by the appended claims, and equivalents thereof.

TABLE 1

| | | | | Refractive |
|---|---|---|---|---|
| Surface | Radius | Thickness | Material | Index |
| 0 | 0.000000 | 45.000000 | | 1 |
| 1 | 0.000000 | 0.000000 | | 1 |
| 2 | 0.000000 | 12.000000 | CAF2 | 1.5592846 |
| 3 | 0.000000 | 1.272434 | | 1 |
| 4 | 198.892477 | 21.983110 | CAF2 | 1.5592846 |
| 5 | −4025.714549 | 39.744210 | | 1 |
| 6 | 0.000000 | 46.500000 | CAF2 | 1.5592846 |
| 7 | 0.000000 | 0.000000 | CAF2 | 1.5592846 |
| 8 | 0.000000 | 60.000000 | CAF2 | 1.5592846 |
| 9 | 0.000000 | 6.692259 | | 1 |
| 10 | −829.066322 | 12.500000 | CAF2 | 1.5592846 |
| 11 | 541.921226 | 10.000000 | | 1 |
| 12 | 0.000000 | 10.000000 | CAF2 | 1.5592846 |
| 13 | 0.000000 | 221.198604 | | 1 |
| 14 | −280.616245 | 15.000000 | CAF2 | 1.5592846 |
| 15 | −833.459972 | 30.170961 | | 1 |
| 16 | −204.892600 | 15.000000 | CAF2 | 1.5592846 |
| 17 | −505.712630 | 26.065904 | | 1 |
| 18 | 0.000000 | 0.000000 | REFL | −1 |
| 19 | 238.885329 | 26.065904 | REFL | 1 |
| 20 | 505.712630 | 15.000000 | CAF2 | 1.5592846 |
| 21 | 204.892600 | 30.170961 | | 1 |
| 22 | 833.459972 | 15.000000 | CAF2 | 1.5592846 |
| 23 | 280.616245 | 221.198604 | | 1 |
| 24 | 0.000000 | 10.000000 | CAF2 | 1.5592846 |
| 25 | 0.000000 | 10.000000 | | 1 |
| 26 | −541.921226 | 12.500000 | CAF2 | 1.5592846 |
| 27 | 829.066322 | 6.692259 | | 1 |
| 28 | 0.000000 | 106.500000 | CAF2 | 1.5592846 |
| 29 | 0.000000 | 32.857249 | | 1 |
| 30 | 0.000000 | 0.000000 | | 1 |
| 31 | 0.000000 | 29.999999 | | 1 |
| 32 | 0.000000 | 84.999999 | | 1 |
| 33 | 500.914501 | 35.904858 | CAF2 | 1.5592846 |
| 34 | −332.011735 | 1.308462 | | 1 |
| 35 | 429.402378 | 21.263793 | CAF2 | 1.5592846 |
| 36 | 5369.897880 | 345.855244 | | 1 |
| 37 | 0.000000 | 10.000000 | CAF2 | 1.5592846 |
| 38 | 0.000000 | 10.000000 | | 1 |
| 39 | 168.278047 | 28.586063 | CAF2 | 1.5592846 |
| 40 | 615.158823 | 40.003100 | | 1 |
| 41 | −216.724300 | 12.500000 | CAF2 | 1.5592846 |
| 42 | 2958.315472 | 30.219424 | | 1 |
| 43 | 1272.002008 | 12.500000 | CAF2 | 1.5592846 |
| 44 | 159.580729 | 25.819752 | | 1 |
| 45 | 248.033135 | 35.547686 | CAF2 | 1.5592846 |
| 46 | −584.310257 | 2.237753 | | 1 |
| 47 | 500.621327 | 24.752251 | CAF2 | 1.5592846 |
| 48 | −535.979529 | 11.542909 | | 1 |
| 49 | 0.000000 | 7.491298 | | 1 |
| 50 | 300.231687 | 22.971014 | CAF2 | 1.5592846 |
| 51 | 627.560215 | 5.156545 | | 1 |
| 52 | 205.726564 | 42.438332 | CAF2 | 1.5592846 |
| 53 | −366.966578 | 14.604302 | | 1 |
| 54 | −187.462212 | 15.000000 | CAF2 | 1.5592846 |
| 55 | −311.082640 | 1.759588 | | 1 |
| 56 | 129.149468 | 37.649423 | CAF2 | 1.5592846 |
| 57 | −4100.995751 | 1.516896 | | 1 |
| 58 | 124.587430 | 23.311150 | CAF2 | 1.5592846 |
| 59 | 266.643686 | 3.695034 | | 1 |
| 60 | 209.850555 | 20.826744 | CAF2 | 1.5592846 |
| 61 | 5566.176088 | 1.103251 | | 1 |
| 62 | 0.000000 | 10.000000 | CAF2 | 1.5592846 |
| 63 | 0.000000 | 8.000000 | | 1 |
| 64 | 0.000000 | 0.000000 | | 1 |

TABLE 2
Aspheric constants

| | | | | | |
|---|---|---|---|---|---|
| FL | 5 | 11 | 17 | 20 | 26 |
| K | 0 | 0 | 0 | 0 | 0 |
| C1 | −3.937073E−10 | 3.001495E−08 | −5.047609E−09 | 5.047609E−09 | −3.001495E−08 |
| C2 | 2.166716E−14 | 1.555785E−13 | 5.517709E−14 | −5.517709E−14 | −1.555785E−13 |
| C3 | −5.475909E−17 | 1.955722E−17 | 1.130124E−18 | −1.130124E−18 | −1.955722E−17 |
| C4 | 1.768062E−20 | −4.630292E−21 | −9.114919E−23 | 9.114918E−23 | 4.690292E−21 |
| C5 | −2.981358E−24 | 9.745401E−25 | 2.906886E−27 | −2.906886E−27 | −9.745401E−25 |
| C6 | 1.984087E−28 | −8.477147E−29 | 4.677766E−32 | −4.677766E−32 | 8.477147E−29 |

| | | | | |
|---|---|---|---|---|
| FL | 33 | 42 | 48 | 57 |
| K | 0 | 0 | 0 | 0 |
| C1 | −1.058775E−08 | 4.975012E−08 | 2.214461E−08 | 4.427822E−08 |
| C2 | 1.241502E−13 | −2.612023E−12 | −5.604852E−14 | 2.050912E−12 |
| C3 | −7.218465E−18 | 3.326327E−18 | −6.010925E−17 | −2.326665E−16 |
| C4 | 9.901785E−22 | 6.788025E−21 | 6.185990E−21 | 4.062044E−20 |
| C5 | −9.049030E−26 | −2.697207E−25 | −6.682225E−25 | −3.869652E−24 |
| C6 | 3.335578E−30 | 2.686456E−29 | 2.081218E−29 | 1.785774E−28 |

TABLE 4
i304c

| Surface | max sin(i) | k |
|---|---|---|
| 33 | 0.477 | 2.991 |
| 34 | 0.357 | 1.914 |
| 35 | 0.313 | 2.408 |
| 36 | 0.242 | 30.149 |
| 37 | 0.252 | |
| 38 | 0.252 | |
| 39 | 0.530 | 0.952 |
| 40 | 0.213 | 3.561 |
| 41 | 0.594 | 1.325 |
| 42 | 0.324 | 18.108 |
| 43 | 0.333 | 7.661 |
| 44 | 0.850 | 0.959 |
| 45 | 0.810 | 1.349 |
| 46 | 0.103 | 3.144 |
| 47 | 0.412 | 2.663 |
| 48 | 0.251 | 2.860 |
| 49 | 0.124 | |
| 50 | 0.374 | 1.615 |
| 51 | 0.116 | 3.417 |
| 52 | 0.415 | 1.128 |
| 53 | 0.746 | 2.055 |
| 54 | 0.850 | 1.075 |
| 55 | 0.615 | 1.819 |
| 56 | 0.332 | 0.864 |
| 57 | 0.666 | 29.879 |
| 58 | 0.416 | 1.077 |
| 59 | 0.721 | 2.712 |
| 60 | 0.718 | 2.332 |
| 61 | 0.851 | 80.822 |
| 62 | 0.852 | |
| 63 | 0.852 | |
| 64 | 0.852 | |

TABLE 4

| Sur- | | | | Refractive | |
|---|---|---|---|---|---|
| face | Radius | Thickness | Material | Index | |
| 0 | 0.000000 | 45.000000 | | 1 | 53.2 |
| 1 | 0.000000 | 0.000000 | | 1 | 63.009 |
| 2 | 0.000000 | 12.000000 | CAF2 | 1.5592846 | 63.009 |
| 3 | 0.000000 | 35.347117 | | 1 | 64.664 |
| 4 | 267.750473 | 19.768598 | CAF2 | 1.5592846 | 74.686 |
| 5 | −1674.962205 | 7.884204 | | 1 | 74.89 |
| 6 | 0.000000 | 46.500000 | CAF2 | 1.5592846 | 74.995 |
| 7 | 0.000000 | 0.000000 | CAF2 | 1.5592846 | 75.316 |
| 8 | 0.000000 | 60.000000 | CAF2 | 1.5592846 | 75.316 |
| 9 | 0.000000 | 7.469396 | | 1 | 75.729 |
| 10 | −829.066322 | 12.500000 | CAF2 | 1.5592846 | 75.772 |
| 11 | −1811.717637 | 10.000000 | | 1 | 76.36 |
| 12 | 0.000000 | 10.000000 | CAF2 | 1.5592846 | 76.92 |
| 13 | 0.000000 | 263.502083 | | 1 | 77.241 |
| 14 | −442.653362 | 15.000000 | CAF2 | 1.5592846 | 90.032 |
| 15 | −9378.405589 | 39.534989 | | 1 | 92.833 |
| 16 | −158.298751 | 15.000000 | CAF2 | 1.5592846 | 94.585 |
| 17 | −417.187702 | 21.639024 | | 1 | 107.042 |
| 18 | 0.000000 | 0.000000 | REFL | −1 | 129.987 |
| 19 | 232.459963 | 21.639024 | REFL | 1 | 110.974 |
| 20 | 417.187702 | 15.000000 | CAF2 | 1.5592846 | 107.569 |
| 21 | 158.298751 | 39.534989 | | 1 | 95.468 |
| 22 | 9378.405589 | 15.000000 | CAF2 | 1.5592846 | 93.983 |
| 23 | 442.653362 | 263.502083 | | 1 | 91.057 |
| 24 | 0.000000 | 10.000000 | CAF2 | 1.5592846 | 72.465 |
| 25 | 0.000000 | 10.000000 | | 1 | 71.997 |
| 26 | 1811.717637 | 12.500000 | CAF2 | 1.5592846 | 71.186 |
| 27 | 829.066322 | 7.469396 | | 1 | 70.395 |
| 28 | 0.000000 | 106.500000 | CAF2 | 1.5592846 | 70.226 |
| 29 | 0.000000 | 32.857249 | | 1 | 67.638 |
| 30 | 0.000000 | 0.000000 | | 1 | 66.393 |
| 31 | 0.000000 | 29.999999 | | 1 | 66.393 |
| 32 | 0.000000 | 85.000000 | | 1 | 65.257 |
| 33 | 289.115342 | 31.717319 | CAF2 | 1.5592846 | 88.18 |
| 34 | −401.382092 | 364.510460 | | 1 | 89.02 |
| 35 | 0.000000 | 10.000000 | CAF2 | 1.5592646 | 96.172 |
| 36 | 0.000000 | 10.000000 | | 1 | 96.294 |
| 37 | 181.173355 | 31.864628 | CAF2 | 1.5592646 | 97.023 |
| 38 | 855.942304 | 42.971206 | | 1 | 95.184 |
| 39 | −269.277849 | 12.500000 | CAF2 | 1.5592846 | 89.309 |
| 40 | −796.238794 | 62.783625 | | 1 | 88.611 |
| 41 | −3414.030817 | 12.500000 | CAF2 | 1.5592846 | 83.62 |
| 42 | 149.400105 | 25.705184 | | 1 | 82.091 |
| 43 | 500.912785 | 21.199470 | CAF2 | 1.5592846 | 85.187 |
| 44 | −767.655718 | 0.949250 | | 1 | 86.595 |
| 45 | 252.074492 | 30.062128 | CAF2 | 1.5592846 | 90.701 |
| 46 | −801.955328 | 10.884174 | | 1 | 90.446 |
| 47 | 0.000000 | 10.355530 | | 1 | 89.033 |
| 48 | 228.094300 | 45.278800 | CAF2 | 1.5592846 | 92.505 |
| 49 | −260.598255 | 12.255589 | | 1 | 91.732 |
| 50 | −175.428260 | 29.063929 | CAF2 | 1.5592846 | 90.15 |
| 51 | −277.579435 | 0.949888 | | 1 | 90.376 |
| 52 | 156.834781 | 26.990533 | CAF2 | 1.5592846 | 82.711 |
| 53 | 650.389367 | 0.949569 | | 1 | 79.679 |
| 54 | 156.068172 | 37.302408 | CAF2 | 1.5592846 | 73.728 |
| 55 | 968.953567 | 0.949031 | | 1 | 63.976 |
| 56 | 133.650014 | 44.050680 | CAF2 | 1.5592846 | 55.435 |
| 57 | 11588.249446 | 1.047897 | | 1 | 34.44 |
| 58 | 0.000000 | 10.000000 | CAF2 | 1.5592846 | 32.821 |
| 59 | 0.000000 | 7.999999 | | 1 | 26.3 |
| 60 | 0.000000 | 0.000000 | | 1 | 13.3 |

TABELLE 5
Aspheric constants

| | | | | | |
|---|---|---|---|---|---|
| FL | 5 | 11 | 17 | 20 | 26 |
| k | 0 | 0 | 0 | 0 | 0 |
| C1 | −6.638531E−09 | 1.348120E−08 | −3.800787E−09 | 3.800787E−09 | −1.348120E−08 |
| C2 | −2.471581E−13 | −2.392370E−13 | 2.471505E−14 | −2.471505E−14 | 2.392370E−13 |
| C3 | 5.002678E−18 | 8.985543E−18 | 2.399767E−18 | −2.399767E−18 | −8.985543E−18 |
| C4 | −1.859158E−21 | −1.922062E−21 | −2.172579E−22 | 2.172579E−22 | 1.922062E−21 |
| C5 | 1.967232E−25 | 3.241939E−25 | 1.060781E−26 | −1.060781E−26 | −3.241839E−25 |
| C6 | −1.026758E−29 | −2.072888E−29 | −7.767085E−32 | 7.767085E−32 | 2.072888E−29 |

| | | | | |
|---|---|---|---|---|
| FL | 33 | 40 | 46 | 53 |
| k | 0 | 0 | 0 | 0 |
| C1 | −1.841639E−08 | 3.172958E−08 | 2.308916E−08 | −7.759806E−09 |
| C2 | 1.051086E−13 | −1.197685E−12 | −4.256684E−13 | 3.970619E−12 |
| C3 | 7.721982E−20 | 8.498259E−18 | −7.176057E−17 | −3.393789E−17 |
| C4 | −4.817260E−22 | 1.156494E−21 | 4.651341E−21 | 3.591669E−21 |
| C5 | 4.439991E−26 | −4.340603E−26 | −6.432512E−25 | 2.378031E−25 |
| C6 | −1.713473E−30 | 5.454278E−30 | 1.825988E−29 | −1.321165E−29 |

TABLE 6

| | | | | Refractive |
|---|---|---|---|---|
| Surface | Radius | Thickness | Material | Index |
| 0 | 0.000000 | 30.000000 | | 1 |
| 1 | 0.000000 | 0.000000 | | 1 |
| 2 | 155.159502 | 21.755047 | CAF2 | 1.5592846 |
| 3 | 364.403465 | 70.338494 | | 1 |
| 4 | 0.000000 | 0.000000 | | 1 |
| 5 | 0.000000 | 100.000567 | | 1 |
| 6 | −210.828069 | 12.500000 | CAF2 | 1.5592846 |
| 7 | −299.922752 | 283.924594 | | 1 |
| 8 | −202.331799 | 15.000000 | CAF2 | 1.5592846 |
| 9 | −803.100781 | 26.083727 | | 1 |
| 10 | −246.374517 | 15.000000 | CAF2 | 1.5592846 |
| 11 | −480.775656 | 26.370456 | | 1 |
| 12 | 0.000000 | 0.000000 | REFL | −1 |
| 13 | 242.631617 | 26.370456 | REFL | 1 |
| 14 | 480.775656 | 15.000000 | CAF2 | 1.5592846 |
| 15 | 246.374517 | 26.083727 | | 1 |
| 16 | 803.100781 | 15.000000 | CAF2 | 1.5592846 |
| 17 | 202.331799 | 283.924594 | | 1 |
| 18 | 299.922752 | 12.500000 | CAF2 | 1.5592846 |
| 19 | 210.828069 | 77.000000 | | 1 |
| 20 | 0.000000 | 0.000000 | | 1 |
| 21 | 0.000000 | −22.671904 | | 1 |
| 22 | 0.000000 | 92.479435 | | 1 |
| 23 | 255.468089 | 35.000395 | CAF2 | 1.5592846 |
| 24 | −307.370308 | 238.910177 | | 1 |
| 25 | 192.854796 | 34.600974 | CAF2 | 1.5592846 |
| 26 | 2250.225958 | 30.911828 | | 1 |
| 27 | −203.748371 | 12.500000 | CAF2 | 1.5592846 |
| 28 | −432.215848 | 110.344209 | | 1 |
| 29 | 360.463008 | 12.500000 | CAF2 | 1.5592846 |
| 30 | 161.404200 | 39.898178 | | 1 |
| 31 | 305.131106 | 35.000228 | CAF2 | 1.5592846 |
| 32 | −711.211289 | 25.012391 | | 1 |
| 33 | 0.000000 | −10.955367 | | 1 |
| 34 | 514.408846 | 30.000157 | CAF2 | 1.5592846 |
| 35 | −696.095559 | 16.412895 | | 1 |
| 36 | 239.410762 | 49.999875 | CAF2 | 1.5592846 |
| 37 | −355.959674 | 17.905009 | | 1 |
| 38 | −234.544019 | 15.000000 | CAF2 | 1.5592846 |
| 39 | −361.352045 | 0.959525 | | 1 |
| 40 | 180.292718 | 45.239002 | CAF2 | 1.5592846 |
| 41 | 479.116558 | 1.631361 | | 1 |
| 42 | 131.146655 | 26.156431 | CAF2 | 1.5592846 |
| 43 | 330.645947 | 6.944054 | | 1 |
| 44 | 134.123600 | 23.381334 | CAF2 | 1.5592846 |
| 45 | 662.928003 | 1.891676 | | 1 |
| 46 | 0.000000 | 10.000000 | CAF2 | 1.5592846 |
| 47 | 0.000000 | 8.000000 | | 1 |

TABLE 7
Aspheric constants

| | | | | | |
|---|---|---|---|---|---|
| FL | 3 | 7 | 11 | 14 | 18 |
| K | 0 | 0 | 0 | 0 | 0 |
| K | 0.000000E+00 | 0.000000E+00 | 0.000000E+00 | 0.000000E+00 | 0.000000E+00 |
| C1 | 2.319336E−08 | 1.536900E−08 | −4.160678E−09 | 4.160678E−09 | −1.596900E−08 |
| C2 | −5.500943E−14 | 1.123738E−13 | 3.656332E−14 | −3.656332E−14 | −1.123738E−13 |
| C3 | −2.029447E−17 | 1.520760E−17 | −4.081046E−19 | 4.081046E−18 | −1.520760E−17 |
| C4 | 4.293677E−21 | 2.911628E−22 | 1.119169E−24 | −1.119189E−24 | −2.911828E−22 |
| C5 | −6.1523876−25 | 9.971686E−26 | 3.571108E−28 | −3.571108E−28 | −9.971586E−26 |
| C6 | 3.64959E−29 | −8.70488E−30 | −1.71268E−34 | 1.71268E−34 | 8.70488E−30 |

| | | | | |
|---|---|---|---|---|
| FL | 23 | 28 | 32 | 41 |
| K | 0 | 0 | 0 | 0 |
| K | 0.000000E+00 | 0.000000E+00 | 0.000000E+00 | 0.000000E+00 |
| C1 | −2.262866E−08 | 3.069070E−08 | 1.751668E−08 | −6.055105E−08 |
| C2 | 2.036199E−13 | −8.368559E−13 | −7.632291E−14 | 5.594600E−12 |
| C3 | −1.280877E−17 | −6.579175E−18 | −7.856393E−18 | −5.462624E−18 |
| C4 | 1.002695E−21 | 3.570042E−22 | 9.186055E−22 | −6.629840E−21 |
| C5 | −1.007825E−25 | 5.074666E−26 | −1.220850E−25 | 3.400131E−25 |
| C6 | 4.73431E−30 | −5.41798E−31 | 4.31222E−30 | −1.35892E−29 |

What is claimed is:

1. Catadioptric projection objective for imaging a pattern arranged in an object surface of the projection objective into the image surface of the projection objective, comprising:
a catadioptric objective part having at least one concave mirror; and
a dioptric objective part, arranged optically downstream of the catadioptric objective part, in which there is situated a pupil surface near the image surface;
wherein situated in a near zone of the pupil surface is at least one concave lens with a concave surface directed towards the pupil surface;
wherein no lens with a strongly curved concave surface having a surface aperture k of less than 0.8 and being directed towards the image surface is situated between the pupil surface and the image surface, with k being the ratio r/D between the radius r of the concave surface and the maximum useful diameter D of the concave surface; and
wherein at least two of four lenses closest to the image surface are produced from a fluoride crystal material and a crystallographic <100> axis of the crystal material is aligned substantially parallel to an optical axis of the projection objective.

2. Projection objective according to claim 1, wherein no lens with a concave surface having a surface aperture k of less than 0.7 and being directed towards the image surface is situated between the pupil surface and the image surface.

3. Projection objective according to claim 1, wherein the fluoride crystal material is calcium fluoride.

4. Projection objective according to claim 1, wherein at least two consecutive lenses made from fluoride crystal material with the same crystallographic orientation are rotated relative to one another about the optical axis such that at least a fraction of a birefringent action of one of the lenses is compensated by the rotated lens following thereupon.

5. Projection objective according to claim 1, wherein the near zone of the pupil surface is a region of relatively large beam diameter near the pupil surface extending on both sides of the pupil surface in an axial direction up to 1.5 times a maximum useful beam bundle diameter in the region of the pupil surface.

6. Projection objective according to claim 1, wherein for at least one concave lens the concave surface directed towards the pupil surface is situated in a region with a substantially changing beam diameter between a region with a small beam diameter and a region with a larger beam diameter, and the concave surface faces the region with a larger beam diameter.

7. Projection objective according to claim 1, wherein at least one concave lens is situated in a region of convergent radiation between the pupil surface and the image surface.

8. Projection objective according to claim 1, wherein at least one concave lens is situated in a region of divergent radiation in the light path upstream of the pupil surface.

9. Projection objective according to claim 1, wherein exactly one concave lens with an image-side concave surface is situated in a region of divergent radiation upstream of the pupil surface, and exactly one concave lens with an object-side concave surface is situated in a region of convergent radiation between the pupil surface and the image surface.

10. Projection objective according to claim 1, wherein at least one concave surface is curved and arranged in such a way that maximum sines, occurring on the concave surface, of the angle of incidence of the transiting radiation are greater than approximately 80% of the image-side numerical aperture NA of the projection objective.

11. Projection objective according to claim 1, wherein the at least one concave surface is arranged in a region in which the numerical aperture of the radiation at the concave surface is less than approximately 80% of the image-side numerical aperture NA of the projection objective.

12. Projection objective according to claim 1, which has an image-side numerical aperture of NA≧0.6.

13. Projection objective according to claim 12, wherein NA≧0.8.

14. Projection objective according to claim 1, wherein at least one of the concave lenses is designed as a meniscus lens.

15. Projection objective according to claim 1, wherein at least one of the concave lenses is designed as a negative meniscus lens.

16. Projection objective according to claim 1, wherein at least one of the concave lenses is a meniscus lens which has a slight sag Q in the range of Q≦1.5, the sag being defined as Q=|((1/r₁+1/r₂)/2)×D|, 1/r₁ and 1/r₂ being the surface curvature of the entrance surface and exit surface, and D being the optically free diameter of the lens.

17. Projection objective according to claim 1, wherein for at least one of the concave lenses a ratio V between a useful volume and a blank volume is greater than approximately 0.3, the useful volume being the volume of the completely processed lens, and the blank volume being the volume of a cylinder circumscribing the finished lens.

18. Projection objective according to claim 17, wherein V>0.4.

19. Projection objective according to claim 17, wherein V>0.3 for all the concave lenses.

20. Projection objective according to claim 1, wherein a sum of the negative refractive powers of all negative lenses in the dioptric objective part is less than approximately 10 m⁻¹.

21. Projection objective according to claim 1, wherein it holds for all the negative lenses j in the near zone of the pupil surface that:
5.0<|fⱼ/L|<0.1, fⱼ being the refractive powers of the individual negative lenses in the near zone of the pupil surface, and L being the length of the total light path along the optical axis between the object surface and the image surface.

22. Projection objective according to claim 1, which has at most three negative lenses in the dioptric objective part.

23. Projection objective according to claim 1, wherein a real intermediate image is formed.

24. Projection objective according to claim 1, which has exactly one concave mirror and an associated beam deflecting device.

25. Projection objective according to claim 1, which is a projection objective with a physical beam splitter.

26. Projection objective according to claim 1, which is a projection objective with a geometrical beam splitter with at least one deflecting mirror.

27. Projection objective according to claim 26, whrein the geometrical beam splitter has two deflecting mirrors.

28. Projection objective according to claim 1, wherein an aperture stop for limiting the beam diameter is positioned in the dioptric objective part.

29. Projection objective according to claim 1, wherein an aperture stop limiting the beam diameter is provided in the catadioptric objective part immediately upstream of the concave mirror.

30. Projection objective according to claim 1, wherein at least two lenses are provided which are associated with a manipulator constructed such that the lenses can be at least one of displaced along the optical axis and decentred and tilted transverse to the optical axis.

31. Projection objective according to claim 1, wherein all the transparent optical components are produced from the same material.

32. Projection objective according to claim 31, wherein the material is calcium fluoride.

33. Projection objective according to claim 1, wherein at least one of a first optical element next to the object surface and a last optical element next to the image surface is formed by a substantially plane-parallel plate.

34. Projection objective according to claim 1, which is designed for ultraviolet light from a wavelength range of between approximately 120 nm and approximately 260 nm.

35. Projection objective according to claim 1, wherein a relay system is inserted between the object surface and the catadioptric objective part such that an image formed by the relay system upstream of the catadioptric objective part forms an object to be imaged onto the image surface by the catadioptric and dioptric objective part arranged optically downstream of the relay system.

36. Projection exposure machine for microlithography, having an illumination system and a catadioptric projection objective, the projection objective being designed in accordance with claim 1.

37. A method for fabricating semiconductor components and other finely structured devices, having the following steps:
providing a mask with a prescribed pattern;
illuminating the mask with ultraviolet light of a prescribed wavelength; and
projecting an image of the pattern onto a light-sensitive substrate arranged in the region of the image plane of a projection objective with the aid of a catadioptric projection objective in accordance with claim 1.

38. Catadioptric projection objective for imaging a pattern arranged in an object surface of the projection objective into the image surface of the projection objective, comprising:
a catadioptric objective part having at least one concave mirror; and
a dioptric objective part, arranged optically downstream of the catadioptric objective part, in which there is situated a pupil surface near the image surface;
wherein situated in a near zone of the pupil surface is at least one concave lens with a concave surface directed towards the pupil surface, where the near zone of the pupil surface is a region of relatively large beam diameter near the pupil surface extending on both sides of the pupil surface in an axial direction up to 1.5 times a maximum useful beam bundle diameter in the region of the pupil surface;
wherein no lens with a strongly curved concave surface having a surface aperture k of less than 0.8 and being directed towards the image surface is situated between the pupil surface and the image surface, with k being the ratio r/D between the radius r of the concave surface and the maximum useful diameter D of the concave surface; and
wherein at least two consecutive lenses made from fluoride crystal material with the same crystallographic orientation are rotated relative to one another about the optical axis such that at least a fraction of a birefringent action of one of the lenses is compensated by the rotated lens following thereupon.

39. Projection objective according to claim 38, wherein the same crystallographic orientation is such that a crystallographic <100> axis of the crystal material is aligned substantially parallel to an optical axis of the projection objective.
